(19) United States
(12) Patent Application Publication
(10) Pub. No.: US 2009/0188570 A1
(43) Pub. Date: Jul. 30, 2009

(54) Rapid inflation device

(75) Inventor: Shirley Lin, Chang Hua (TW)

Correspondence Address: BACON & THOMAS, PLLC, 625 SLATERS LANE, FOURTH FLOOR, ALEXANDRIA, VA, 22314-1176, US

(73) Assignee: JIN DAI AUTO SUPPLIES CO., LTD., CHANG HUA (TW)

(21) Appl. No.: 12/155,706

(22) Filed: Jun. 9, 2008

(30) Foreign Application Priority Data
Jan. 30, 2008 (TW) 97202008

(51) Int. Cl. B60C 23/10; F16K 15/20

(52) U.S. Cl. 137/231; 137/223

(57) ABSTRACT

A rapid inflation device for connecting a forced air supply source to the air nozzle of a tire that has an air valve mounted therein for controlling input and output of air is disclosed to include a casing for connection to the air nozzle, an air intake connector rotatably mounted on the casing for the connection of the forced air supply source, and a valve pickup device for carrying the air valve away from the air nozzle to let forced air pass from the forced air supply source into the inside of the tire freely or to let tire air be discharged out of the tire through the same circulation path. By means of rotating the air intake connector forwards or backwards, the forced air supply source is connected to or disconnected from the rapid inflation device.

### BACKGROUND OF THE INVENTION

1. Field of the Invention

The present invention relates to an inflation apparatus and more particularly, to a rapid inflation device for inflating a tire rapidly.

2. Description of the Related Art

Conventionally, when wishing to inflate a tire, the user must attach the charging connector of a tire pump to the air nozzle of the tire to be inflated, and then operate the tire pump to pump air into the tire. Because the air nozzle has an air valve accommodated therein, force air is slowly pumped into the tire. During pumping, the user must hold the charging connector firmly in place, keeping the charging connector against the air valve for letting forced air pass through the air nozzle into the inside of the tire.

The aforesaid tire inflation method has the drawback of slow inflation speed. Therefore, an improved inflation method is used. According to this improved inflation method, a spanner is used to remove the air valve out of the air nozzle before connection of the discharging connector of a tire pump to the air nozzle. After removal of the air valve from the air nozzle, the user can pump forced air into the inside of the tire rapidly.

However, the aforesaid improved inflation method is inconvenient to perform. When dismounting the air valve, the user must hold the air nozzle with one hand and then operate the spanner with the other hand. Further, when mounting the discharging connector of the tire pump, a big amount of the internal air of the tire will escape from the tire. Therefore, this improved inflation method of inflating the tire after removal of the air valve still cannot eliminate the problems of slow inflation speed and possible air leakage. Further, the air valve may be threaded into the air nozzle overtightly after an inflation operation, causing damage to the air nozzle and the air valve. To a tire that is used with a tire pressure monitoring system, the air nozzle is installed in the tire pressure monitoring system.

Under this situation, the replacement of the air nozzle is not easy.

### SUMMARY OF THE INVENTION

The present invention has been accomplished under the circumstances in view. It is one object of the present invention to provide a rapid inflation device, which is easy to operate and facilitates rapid inflation of a tire.

To achieve this and other objects of the present invention, a rapid inflation device is provided connectable between an air nozzle of a tire and a forced air supply source for enabling the forced air supply source to output forced air into the tire to inflate the tire. The air nozzle comprises an air valve that controls air input and output of the tire. The rapid inflation device comprises a casing, which is detachably connectable to the air nozzle and comprises an air intake passage and at least one through hole connecting the air intake passage to the outside of the casing, an air intake connector, which is capped on the casing over the at least one through hole to connect the forced air supply source to the casing and rotatable at a fixed point relative to the casing, and a valve pickup device, which is inserted through the air intake passage of the casing and movable between a first position and a second position. The valve pickup device comprises a pickup tip disposed at the front side thereof. The pickup tip is forced into engagement with the air valve and the air valve blocks the air nozzle when the valve pickup device is moved to the first position. The pickup tip carries the air valve out of the air nozzle when the valve pickup device is moved away from the first position to the second position.

Further, when the valve pickup device is in the second position, the output forced air of the forced air supply source is allowed to pass through the air intake connector and the at least one through hole and the air intake passage of the casing into the inside of the tire via the air nozzle, or the internal air of the tire can be discharged to the atmosphere through the same circulation path. Further, the forced air supply source can be connected to or disconnected from the rapid inflation device by means of rotating the air intake connector.

### BRIEF DESCRIPTION OF THE DRAWINGS

FIG. 1 is an exploded view of a rapid inflation device in accordance with a first embodiment of the present invention.

FIG. 2 is a sectional assembly view of the rapid inflation device in accordance with the present invention.

FIG. 3 is a schematic sectional view of the present invention, showing the operation of the rapid inflation device (I).

FIG. 4 is a schematic sectional view of the present invention, showing the operation of the rapid inflation device (II).

FIG. 5 is a schematic sectional view of the present invention, showing the operation of the rapid inflation device (III).

FIG. 6 is a sectional assembly view of a rapid inflation device in accordance with a second embodiment of the present invention.

### DETAILED DESCRIPTION OF THE INVENTION

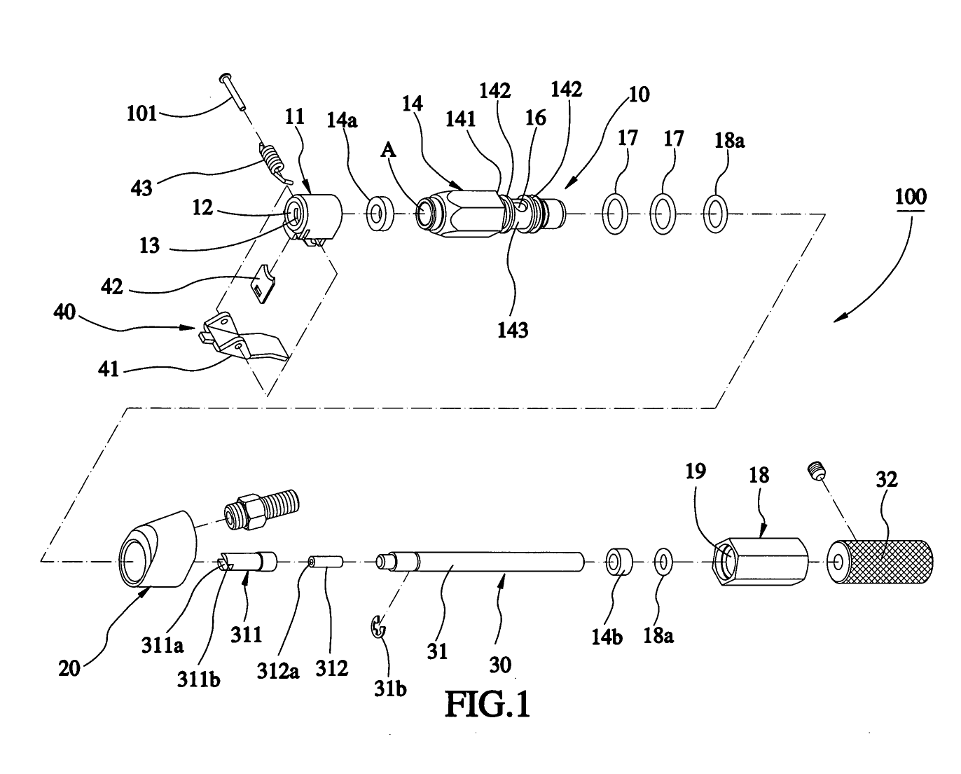

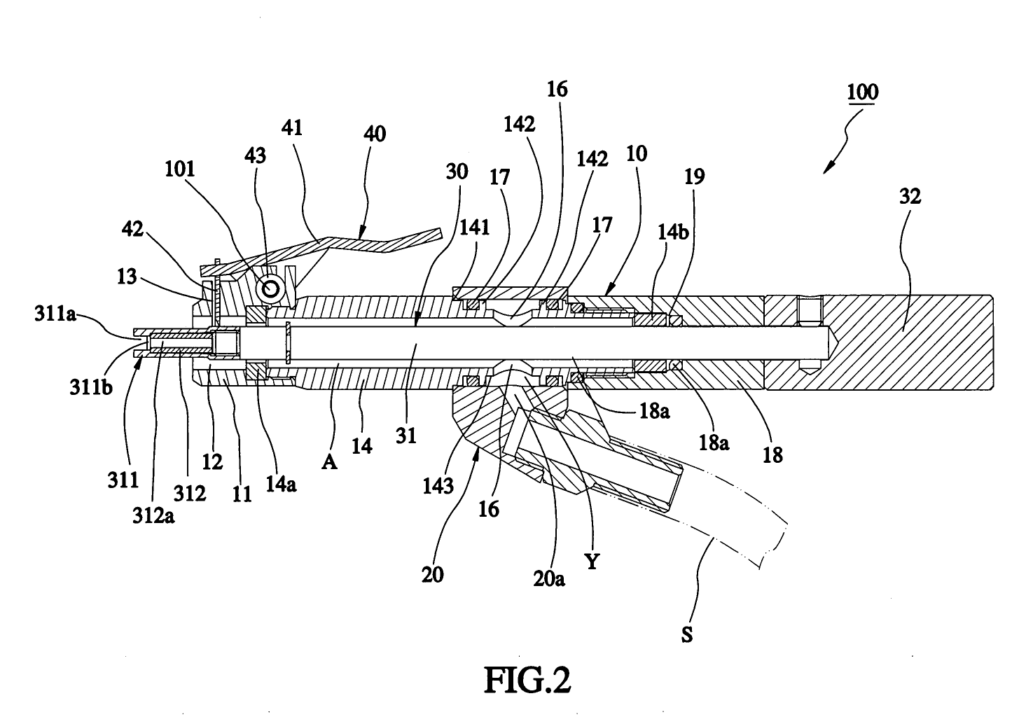

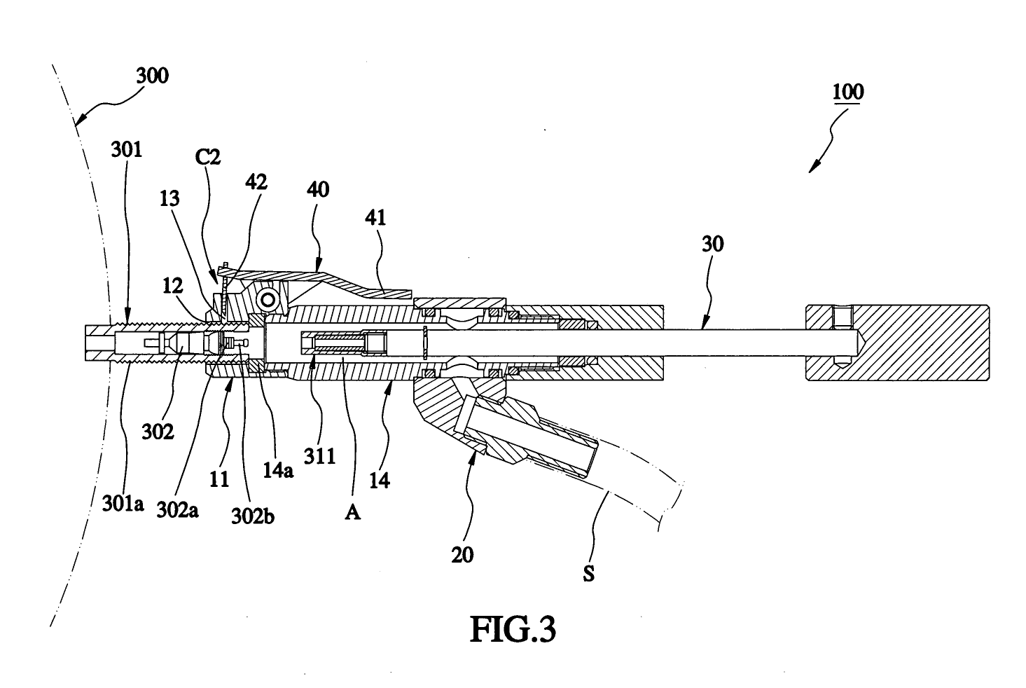

FIGS. 1 and 2 illustrate a rapid inflation device 100 in accordance with a first embodiment of the present invention. FIGS. 3-5 illustrate the operation flow of the rapid inflation device 100 after connection to a tire 300. The tire 300 comprises an air nozzle 301. The air nozzle 301 has an outer thread 301a disposed on the outside, and an air valve 302 disposed on the inside for controlling input of air into the tire 300 and output of air out of the tire 300. The air valve 302 is threaded into the inside of the air nozzle 301, having a front retaining block 302a and a valve pin 302b. The rapid inflation device 100 is installed in the air nozzle 301 for the connection of a forced air supply source S. According to this embodiment, the rapid inflation device 100 is comprised of a casing 10, an air intake connector 20, a valve pickup device 30, and an operating device 40.

Referring to FIGS. 1 and 2 again, the casing 10 comprises a head 11, a endpiece 18, a body 14 axially connected between the head 11 and the endpiece 18, and an air intake passage A axially extending through the head 11, the body 14 and the endpiece 18. The air intake passage A is connected to the forced air supply source S through the air intake connector 20.

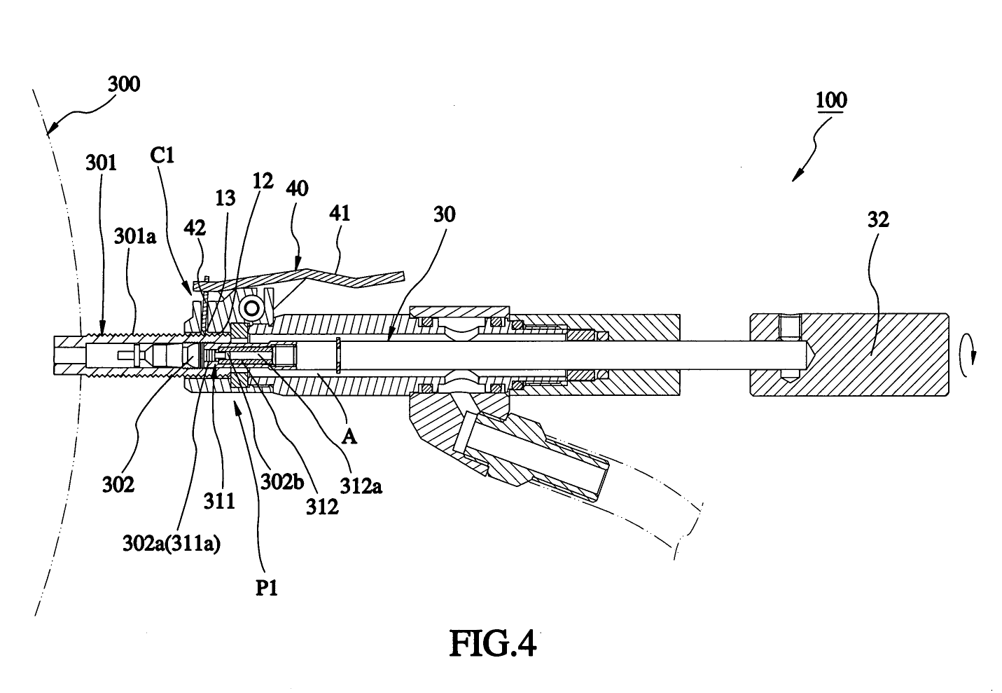

The head 11 has an axial hole 12 and a radial slot 13. The axial hole 12 is in communication with the radial slot 13. Further, the axial hole 12 is in communication with the air intake passage A. As shown in FIG. 4, the axial hole 12 is for connection to the air nozzle 301 to have the air nozzle 301 be in communication with the air intake passage A.

The body 14 is a hollow barrel surrounding the air intake passage A and connected with its front side threaded into the rear side of the head 11, having a shoulder 141 formed on the periphery, two annular grooves 142 extending around the periphery and disposed at one side relative to the shoulder 141, a contracted section 143 located between the two annular grooves 142, and two through holes 16 radially cut through the contracted section 143 in communication with the air intake passage A. Further, two seal members 17 (for example, rubber rings) are respectively fastened to the annular grooves 142. Further, a seal ring 14a is mounted inside the head 11 and retained between the head 11 and the body 14.

The endpiece 18 is threaded onto the rear side of the body 14, defining a first accommodation chamber 19 that extends axially through the front and rear sides thereof for accommodating a stop block 14b and two seal rings 18a to enhance the air tightness of the connection between the body 14 and the endpiece 18.

The air intake connector 20 is sleeved onto the body 14 of the casing 10, having one end stopped against the shoulder 141 and the other end stopped against the endpiece 18. After installation, the air intake connector 20 is prohibited from axial displacement relative to the casing 10, however it can be rotated relative to the casing 10. Further, the air intake connector 20 is pressed on the two seal members 17 so that an annular air intake space Y is defined within the air intake connector 20 and outside the contracted section 143 of the body 14 between the two seal members 17. The annular air intake space Y is in communication with the air intake passage A through the two through holes 16. Further, the air intake connector 20 defines therein an air passage 20a in communication between the forced air supply source S and the air intake passage A. Based on the aforesaid structure, excellent airtight status between the forced air supply source S and the air intake passage A is maintained, avoiding air leakage.

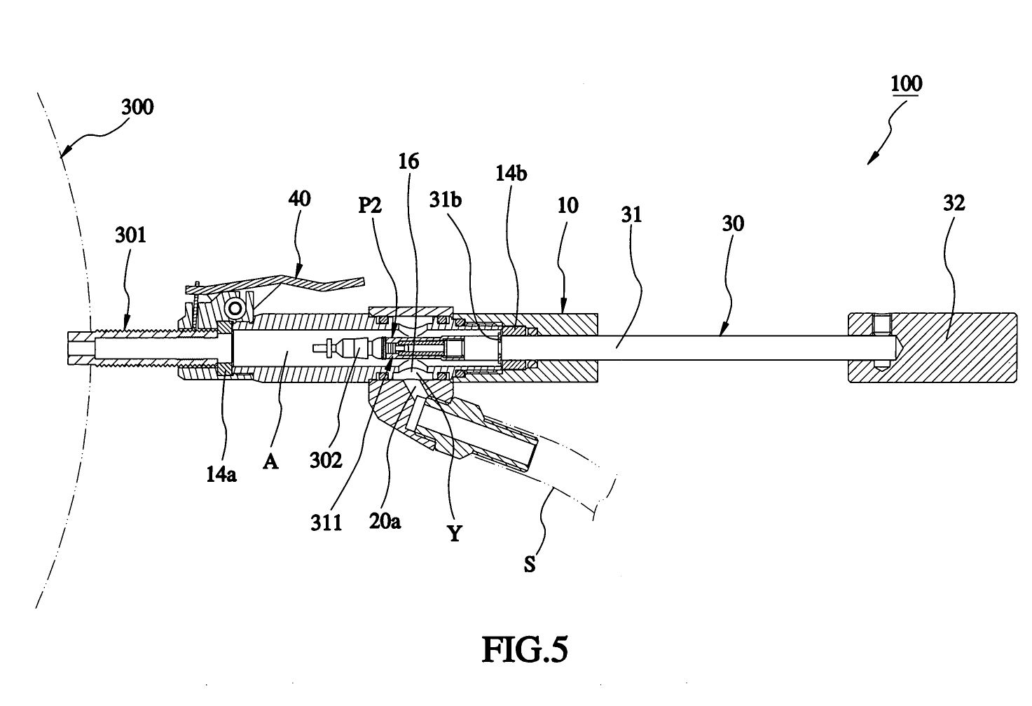

The valve pickup device 30 is a rod member comprised of a device body 31 and a device endpiece 32. The device body 31 is inserted through the axial hole 12 of the head 11, the air intake passage A of the body 14 and the first accommodation chamber 19 of the endpiece 18, having a pickup tip 311 provided at the front side. The pickup tip 311 has a retaining groove 311a at the front side, and a hole 311b in the retaining groove 311a. The pickup tip 311 has mounted therein an elastic block 312. According to this embodiment, the elastic block 312 is made of silicon rubber. Other rubber material may be used for making the elastic block 312. The elastic block 312 has a retaining hole 312a corresponding to the hole 311b of the pickup tip 311. The valve pickup device 30 is movable between a first position P1 (see FIG. 4) and a second position P2 (see FIG. 5). When the valve pickup device 30 is in the first position P1, see FIGS. 2 and 4, the pickup tip 311 of the valve pickup device 30 is connected with the air valve 302 of the air nozzle 301. At this time, the air valve 302 blocks the air nozzle 301, the front retaining block 302a enters the retaining groove 311a of the pickup tip 311, and the valve pin 302b of the air valve 302 is inserted through the hole 311b of the pickup tip 311 into the retaining hole 312a of the elastic block 312. After insertion of the valve pin 302b of the air valve 302 into the hole 312a of the elastic block 312, the elastic block 312 secures the valve pin 302b of the air valve 302 subject to its elastic material property. When the valve pickup device 30 is in the second position P2, see FIG. 5, the pickup tip 311 carried the air valve 302 away from the air nozzle 301. According to this embodiment, mounting/dismounting of the air valve 302 of the air nozzle 311 is achieved by means of rotating the valve pickup device 30 clockwise/counter-clockwise to move the pickup tip 311 forwards/backwards. When the pickup tip 311 is rotated forwards, it is forced into engagement with the air valve 302. When the pickup tip 311 is rotated backwards, it carries the air valve 302 away from the air nozzle 301. Further, the device body 31 has a retainer ring 31b fastened to the periphery near the front end. When the valve pickup device 30 is extending out of the casing 10, the retainer ring 31b will be stopped at the stop block 14b, limiting the moving range of the valve pickup device 30.

The operating device 40 is installed in the head 11 of the casing 10, comprised of a lever 41, a locking plate 42 and a spring member 43. A pin 101 is inserted through the locking plate 42, the spring member 43 and the head 11 to pivotally connect the lever 41 to the head 11 of the casing 10. Further, the locking plate 42 has its rear side fastened to the front side of the lever 41 and its front side inserted into the radial slot 13. The spring member 43 provides a return force to hold the lever 41 in a locking position C1 (see FIG. 4). At this time, the front side of the locking plate 42 extends through the radial slot 13 and is forced into engagement with the outer thread 301a. When the lever 41 is moved from a locking position C1 to an unlocking position C2 by an external force (see FIG. 3), the front side of the locking plate 42 is kept away from the outer thread 301a.and suspending in the radial slot 13. By means of the operating device 40, the mounting/dismounting operation between the rapid inflation device 100 and the air nozzle 301 is easy and quick.

It is to be understood that the mounting/dismounting operation between the rapid inflation device 100 and the air nozzle 301 is not limited to the aforesaid method. Alternatively, the head 11 can be made having an inner thread for threading onto the outer thread 301a of the air nozzle 301. Any suitable conventional technique may be employed.

After understanding of the structure of the rapid inflation device 100, the functioning of the rapid inflation device 100 is described hereinafter.

FIGS. 3-5 illustrate the inflation operation of the rapid inflation device 100 to inflate the tire 300. At first, as shown in FIG. 3, turn the lever 41 of the operating device 40 downwards to the unlocking position C2, opening the axial hole 12 for the insertion of the air nozzle 31. Thereafter, release the lever 41 of the operating device 40 to let the lever 41 be returned by the spring member 43 to the locking position C1, as shown in FIG. 4, forcing the front side of the locking plate 42 into engagement with the outer thread 301a of the air nozzle 301, and therefore the rapid inflation device 100 is locked to the air nozzle 301. It is to be understood that the front side of the air nozzle 301 is tightly stopped against the seal ring 14a at this time, and therefore the connection between the air nozzle 301 and the air intake passage A is maintained in an excellent airtight status, avoiding air leakage. Thereafter, as shown in FIGS. 4 and 5, move the valve pickup device 30 forwards to the first position P1 to force the pickup tip 311 into connection with the air valve 302 of the air nozzle 301, and then rotate the device endpiece 32 of the valve pickup device 30. When rotating the device endpiece 32, the pickup tip 311 is driven to rotate the air valve 302 outwards relative to the air nozzle 301. Thereafter, as shown in FIG. 5, move the valve pickup device 30 backwards from the first position P1 to the second position P2, carrying the air valve 302 out of the air nozzle 301, allowing air communication between the air intake passage A of the casing 10 and the inside of the tire 300 through the air nozzle 301. At this time, the user can start the forced air supply source S to output forced air in proper order through the air passage 20a of the air intake connector 20, the air intake space Y, the through holes 16 of the casing 10 and the air intake passage A into the inside of the tire 300 via the air nozzle 301 that does not have the air valve 302 set therein at this time, thereby rapidly inflating the tire 300. After the tire 300 has been inflated to the saturated status, move the valve pickup device 30 forwards to insert the air valve 302 into the inside of the air nozzle 301, and then rotate the device endpiece 32 of the valve pickup device 30 in the reversed direction to fasten the air valve 302 to the air nozzle 301, and then operate the operating device 40 for allowing disconnection of the rapid inflation device 100 from the air nozzle 301, and therefore the tire 300 inflation operation is done.

According to this embodiment, when the air valve 302 is removed from the air nozzle 301 by the valve pickup device 30, the tire 300, the rapid inflation device 100 and the forced air supply source S constitute an airtight inflation system. Therefore, the user can accurately control the internal air pressure of the tire 300 simply by means of controlling the on/off status of the tire pressure gage-equipped forced air supply source S, eliminating the drawback of the conventional method of repeatedly inflating the tire and discharging the tire pressure.

Further, the invention can also be used as a tool to rapidly discharge the tire pressure. In other word, we can use the rapid inflation device 100 to remove the air valve 302 out of the air nozzle 301, and then disconnect the forced air supply source S from the rapid inflation device 100, allowing the internal air of the tire 300 to be discharged through the air nozzle 301 without the air valve 302 and the rapid inflation device 100 to the atmosphere.

As stated above, during the inflation and discharge process, the air nozzle 301 is without the air valve 302, and therefore air can pass the air nozzle 301 freely, achieving rapid inflation or pressure discharge. Further, by means of fixed-point rotation of the air intake connector 20, the matching operation between the rapid inflation device 100 and the forced air supply source S is smooth and convenient, avoiding interference due to positioning of the forced air supply source S or the tire 300. Further, during the inflation process, the user can easily achieve the operation simply by means of using one single tool (the rapid inflation device 100). When compared to the conventional method of using two tools to achieve inflation, the invention has rapid inflation and easy operation characteristics and avoids air leakage when changing the tool.

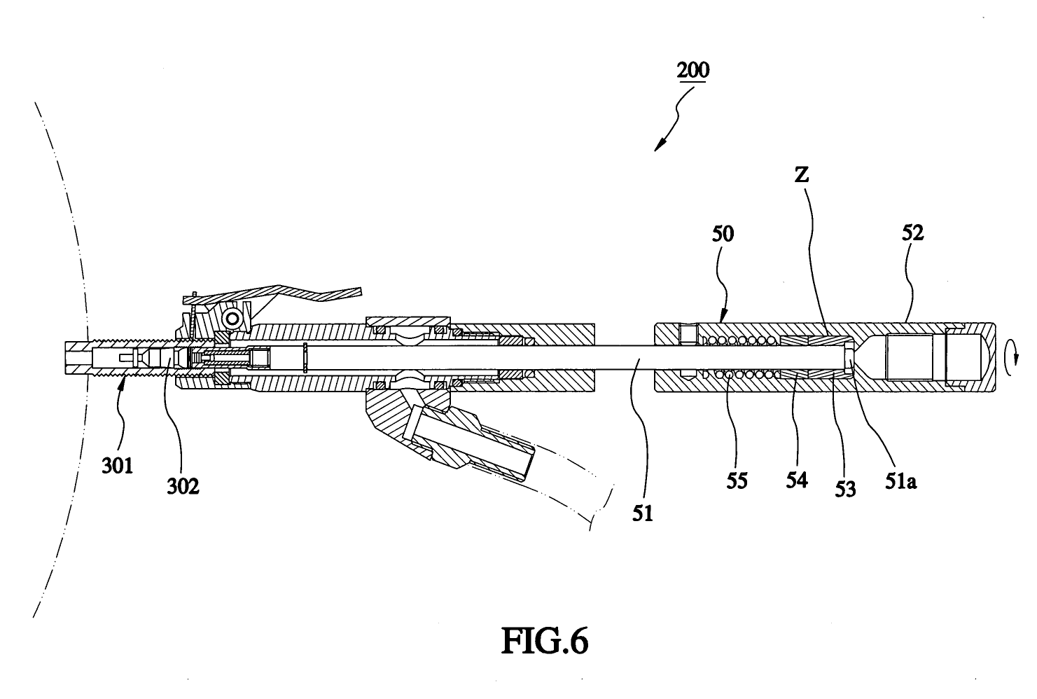

FIG. 6 illustrates a rapid inflation device 200 in accordance with a second embodiment of the present invention. This second embodiment is substantially similar to the aforesaid first embodiment with the exception of the structure of the valve pickup device.

According to this second embodiment, the valve pickup device 50 comprises a torque mechanism, i.e., the device endpiece 52 of the valve pickup device 50 has an accommodation chamber Z that accommodates a first toothed member 53, a second toothed member 54 and a spring member 55. The first toothed member 53 is fixedly connected to the rear end 51a of the device body 51. The second toothed member 54 is fixedly fastened to the inside wall of the device endpiece 52. The spring member 55 forces the second toothed member 54 into engagement with the first toothed member 53. When rotating the air valve 302 into the inside of the air nozzle 301 after inflation of the tire, the force of the spring member 55 that forces the second toothed member 54 into engagement with the first toothed member 53 is greater than the resisting force produced during rotating the air valve 302 into the inside of the air nozzle 301, and the two toothed members 53 and 54 are kept engaged together and prohibited from rotation relative to each other. This condition indicates that the air valve 302 has not yet been completely threaded into the inside of the air nozzle 301. However, it is to be understood that the air valve 302 has blocked the air nozzle 301 at this time, reaching a certain airtight status. When continuously rotating the air valve 302 to the tightness status, the resisting force thus produced is greater than the force of the spring member 55 that forces the second toothed member 54 into engagement with the first toothed member 53, therefore the second toothed member 54 is rotated relative to the first toothed member 53, producing sound. This sound minds the user that the air valve 302 has reached the rightness status, avoiding over tight fitting and further possible damage of the air valve 301 and the air nozzle 302 (damage of the inner thread of the air nozzle 301 and the outer thread of the air valve 302), i.e., the use of the rapid inflation device 200 to mount the air valve 302 prevents over tight fitting between the air valve 302 and the air nozzle 301, thereby lowering the frequency of the replacement of the air nozzle of a conventional tire pressure monitoring system and the related maintenance cost.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rapid inflation device is provided connectable between an air nozzle of a tire and a forced air supply source for enabling said forced air supply source to inflate said tire, said air nozzle comprising an air valve that controls air input and output of said tire, the rapid inflation device comprising:
a casing detachably connectable to said air nozzle, said casing comprising an air intake passage and at least one through hole connecting said air intake passage to the outside of said casing;
an air intake connector capped on said casing over said at least one through hole to connect said forced air supply source to said casing and rotatable at a fixed point relative to said casing;
a valve pickup device inserted through said air intake passage of said casing and movable between a first position and a second position, said valve pickup device comprising a pickup tip disposed at a front side thereof; and
wherein said pickup tip is forced into engagement with said air valve and said air valve blocks said air nozzle when said valve pickup device is moved to said first position; said pickup tip carries said air valve out of said air nozzle for letting said forced air supply source output a forced air through said air intake connector and said at least one through hole and said air intake passage of said casing into the inside of said tire via said air nozzle when said valve pickup device is moved away from said first position to said second position.

2. The rapid inflation device, as claimed in claim 1, wherein said is threaded into said air nozzle, and rotating said valve pickup device forwards/backwards causes said pickup tip to rotatably move said air valve inwards/outwards relative to said air nozzle.

3. The rapid inflation device, as claimed in claim 2, wherein air valve comprises a front retaining block and a valve pin; said pickup tip comprises a front retaining groove, a hole in said front retaining groove, and an elastic block mounted therein, said elastic block having a retaining hole corresponding to the hole in said front retaining groove of said pickup tip, said front retaining block of said air valve being inserted into said front retaining groove of said pickup tip to force said valve pin into the hole in said front retaining groove of said pickup tip and into engagement with the retaining hole of said elastic block.

4. The rapid inflation device, as claimed in claim 3, wherein elastic block is a silicon rubber block.

5. The rapid inflation device, as claimed in claim 1, wherein said casing comprises:
a head for connection to said air valve;
a body, said body defining said air intake passage and being threaded with a front side thereof onto said head, said body having a contracted section that has said at least one through hole formed therein; and
an endpiece threaded onto a rear side of said body opposite to said head to prohibit axial displacement of said air intake connector relative to said casing.

6. The rapid inflation device, as claimed in claim 5, wherein said casing body of said casing comprises a shoulder, two annular grooves extending around the periphery thereof, and two seal members respectively fastened to said annular grooves; said contracted section of said body is defined between said two annular grooves; said air intake connector has two opposite ends respectively stopped against said shoulder and said endpiece, defining with said contacted section an annular air intake space in communication with said at least one through hole.

7. The rapid inflation device, as claimed in claim 6, wherein said air nozzle has an outer thread extending around the periphery of an outer end thereof; the rapid inflation device further comprising a locking plate and an operating device provided at a front side of said casing and movable between a locking position where said locking plate is forced into engagement with the outer thread of said air nozzle and an unlocking position where said locking plate is disengaged from said outer thread of said air nozzle.

8. The rapid inflation device, as claimed in claim 7, wherein said head of said casing comprises an axial hole in communication with said air intake passage for receiving said air nozzle, and a radial slot in communication with said axial hole; said operating device comprises a lever pivotally connected to the front side of said casing and a spring member that provides a return force to said lever to hold said lever in said locking position; said locking plate is inserted into said radial slot and movable with said lever between said locking position and said unlocking position.

9. The rapid inflation device, as claimed in claim 1, wherein said valve pickup device comprises a device body and a device endpiece, said device body being inserted in said air intake passage of said casing and having a front side provided with a pickup tip and a rear side connected with said device endpiece, said device endpiece being disposed outside said casing and defining therein an accommodation chamber; said valve pickup device further comprises a first toothed member fixedly connected to said device body, and received inside said accommodation chamber, a second toothed member fixedly fastened to said device endpiece and received inside said accommodation chamber, and a spring member that imparts a spring force to said second toothed member to force said second toothed member into engagement with said first toothed member.
